(19) United States
(12) Patent Application Publication
(10) Pub. No.: US 2019/0185350 A1
(43) Pub. Date: Jun. 20, 2019

(54) SYSTEMS AND METHODS FOR IMPROVING PERFORMANCE OF FORWARD OSMOSIS SYSTEMS

(71) Applicant: Oasys Water LLC, Dover, DE (US)

(72) Inventors: Christopher DROVER, Watertown, MA (US); Leah STASCHKE, Guilford, CT (US); Eric MAXWELL, Charlestown, MA (US); Seth MCFAYDEN, Plymouth, MA (US)

(21) Appl. No.: 16/322,220

(22) PCT Filed: Aug. 3, 2017
(86) PCT No.: PCT/US2017/045272

§ 371 Date: Jan. 31, 2019

Related U.S. Application Data
(60) Provisional application No. 62/371,122, filed on Aug. 4, 2016.

(51) Int. Cl. C02F 1/44; B01D 61/00; B01D 61/58

(52) U.S. Cl. CPC C02F 1/445; B01D 61/002; C02F 2103/08; B01D 2317/02; B01D 2317/04; B01D 61/58

(57) ABSTRACT

A system feed inlet is connected to a forward osmosis (FO) element bank. A system feed transfer directs fluid flow from the FO element bank through a system feed outlet to a second FO element bank through a system feed inlet. A system draw transfer directs indirect fluid flow from the second FO element bank to the first FO element bank.

### CROSS-REFERENCE TO RELATED APPLICATIONS

This application is being filed on 3 Aug. 2017, as a PCT International patent application, and claims priority to U.S. Provisional Patent Application Ser. No. 62/371,122, filed Aug. 4, 2016, the disclosure of which is hereby incorporated by reference herein in its entirety.

### INTRODUCTION

Forward osmosis is used for desalination, wastewater treatment, and other industrial processes. In general, a forward osmosis desalination process involves a container having two chambers separated by a semi-permeable membrane. One chamber contains seawater or other impaired water source. The other chamber contains a concentrated solution that generates a concentration gradient across the membrane. This gradient draws water from the seawater across the membrane, which selectively permits water, but not salts, to pass into the concentrated solution. Gradually, the water entering the concentrated solution dilutes the solution. The solutes are then removed from the dilute solution to generate potable water.

### SUMMARY

In one aspect, the invention relates a forward osmosis system having a system feed inlet, a first forward osmosis (FO) element bank connected to the system feed inlet having a plurality of primary FO elements, a second FO element bank having a plurality of secondary FO elements, a system feed transfer configured for direct fluid flow from the first FO element bank to the second FO element bank, a system draw inlet connected to the second FO element bank, a system draw outlet connected to the first FO element bank, and a system draw transfer configured for indirect fluid flow from the second FO element bank to the first FO element bank.

In various embodiments of the invention, the number of FO elements in the first and second banks may be the same, may be split into subsets and may include different numbers of elements in each bank and/or subset to suit a particular application. For example, there could be a greater number of membrane elements in the second bank versus the first bank. Generally, the system draw transfer includes one or more valves, sensors, or controls to direct the draw solution to the various membrane banks. In some embodiments, the system draw transfer also includes a bypass tank, which can be in fluid communication with a separation system for separating draw solutes and/or a product solvent from the draw solution. In some embodiments, the plurality of primary FO elements include a first subset of primary FO elements and a second subset of primary FO elements having a number greater than the first subset of primary FO elements. The forward osmosis system may also include a feed system manifold connecting the first subset of primary FO elements and the second subset of primary FO elements. The plurality of secondary FO elements may also include a first subset of secondary FO elements and a second subset of secondary FO elements. In some embodiments, the number of elements in the subsets may be equal. The system feed transfer can connect the second subset of primary FO elements to the second FO element bank and can include a manifold. In some cases, a feed outlet of a single one of the first subset of secondary FO elements is connected to a feed inlet of a single one of the second subset of secondary FO elements.

In another aspect, the invention relates to a forward osmosis system having a plurality of FO element banks including forward osmosis membranes having first and second opposing sides; a feed solution inlet; a feed solution outlet, a feed solution flow path configured for direct fluidic communication from the feed solution inlet, through the plurality of FO element banks via the first sides of the forward osmosis membranes, and to the feed solution outlet; a draw solution inlet; a draw solution outlet; and a draw solution flow path configured for indirect fluidic communication from the draw solution inlet, through the plurality of FO element banks via the second sides of the forward osmosis membranes, and to the draw solution outlet.

In various embodiments of the foregoing aspect of the invention, the draw solution flow path includes a bypass tank for temporarily retaining at least a first portion of the draw solution in the draw solution flow path. The bypass tank may include a bypass line for diverting at least a second portion of the draw solution in the bypass tank to, for example, a separation system. In various embodiments, the forward osmosis membranes have different physical configurations, such as different leaf lengths and/or spacer thicknesses.

In yet another aspect, the invention relates to a process for concentrating a feed stream via forward osmosis. The process includes the steps of providing a first bank of FO membrane elements, providing a second bank of FO membrane elements, introducing a feed stream into the first bank of FO membrane elements and then the second bank of FO membrane elements, introducing a draw solution into the second bank of FO membrane elements, introducing the draw solution exiting the second bank of FO membrane elements into a bypass tank, introducing at least a portion of the draw solution from the bypass tank into the first bank of FO membrane elements, and fluxing a portion of a solvent across the membrane elements from the feed stream into the draw solution.

In various embodiments, the process includes the step of directing the draw solution exiting the first bank of FO membrane elements to a separation process to separate draw solutes from the solvent that fluxed across the membrane banks from the feed stream to the draw solution. In addition, the process can include the step of directing a second portion of the draw solution from the bypass tank to the separation process. In some embodiments, the feed stream and draw solution are introduced into the banks of FO membrane elements on opposite sides of the membranes and in a counter-flow orientation. The process can also include the step of periodically rotating individual membrane elements between membrane banks.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a schematic representation of a forward osmosis (FO) system for the extraction of a solvent;

FIG. 2 is a schematic representation of one application of the system of FIG. 1;

FIG. 3 is a schematic representation of a pyramid membrane configuration for a forward osmosis system,

FIGS. 4-6 depict alternative examples of membrane configurations for forward osmosis systems,

FIG. 7 is a schematic representation of a thermal recovery system for use with a forward osmosis system;

FIG. 8 depicts performance data for the various forward osmosis systems described herein;

FIG. 9 is a schematic representation of an alternative forward osmosis membrane array; and

FIG. 10 is a schematic representation of a membrane element rotation process.

### DETAILED DESCRIPTION

An osmotic method for extracting water from an aqueous solution may generally involve exposing the aqueous solution to a first surface of a forward osmosis membrane. A second solution, or draw solution, with an increased concentration relative to that of the aqueous solution may be exposed to a second opposed surface of the forward osmosis membrane. Water may then be drawn from the aqueous solution through the forward osmosis membrane and into the second solution generating a water-enriched solution via forward osmosis, which utilizes fluid transfer properties involving movement from a less concentrated solution to a more concentrated solution. The water-enriched solution, also referred to as a dilute draw solution, may be collected at a first outlet and undergo a further separation process to produce purified water. A second product stream, i.e., a depleted or concentrated aqueous process solution, may be collected at a second outlet for discharge or further treatment. Alternatively, the various systems and methods described herein can be carried out with non-aqueous solutions.

A forward osmosis module or element may include one or more forward osmosis membranes. The forward osmosis membranes may generally be semi-permeable, for example, allowing the passage of water, but excluding dissolved solutes therein, such as sodium chloride, ammonium carbonate, ammonium bicarbonate, and ammonium carbamate. Many types of semi-permeable membranes are suitable for this purpose provided that they are capable of allowing the passage of water (i.e., the solvent) while blocking the passage of at least substantially all of the solutes and not reacting with the solutes in the solution. At least one forward osmosis membrane may be positioned within a housing or casing that defines the module or element. The housing may generally be sized and shaped to accommodate the membranes positioned therein. For example, the housing may be substantially cylindrical if housing spirally wound forward osmosis membranes. The housing of the module may contain inlets to provide feed and draw solutions to the module as well as outlets for withdrawal of product streams from the module. In some embodiments, the housing may provide at least one reservoir or chamber for holding or storing a fluid to be introduced to or withdrawn from the module. In at least one embodiment, the housing may be insulated.

A forward osmosis module or element may generally be constructed and arranged so as to bring a first solution and a second solution into contact with first and second sides of a semi-permeable membrane, respectively. Although the first and second solutions can remain stagnant, it is preferred that both the first and second solutions are introduced by cross flow, i.e., flows parallel to the surface of the semipermeable membrane. This may generally increase membrane surface area contact along one or more fluid flow paths, thereby increasing the efficiency of the forward osmosis processes. In some embodiments, the first and second solutions may flow in the same direction. In other embodiments, the first and second solutions may flow in opposite directions. In at least some embodiments, similar fluid dynamics may exist on both sides of a membrane surface. This may be achieved by strategic integration of the one or more forward osmosis membranes in the module or housing.

Generally, it is desirable to recover the draw solutes from the diluted second solution for reuse, typically with a separation system in fluid communication with the FO module(s). The separation system may strip solutes from dilute draw solution to produce product water substantially free of the solutes. In some examples, the separation system may include a distillation column or other thermal or mechanical recovery mechanism, for example, a filtration system, such as a reverse osmosis module. Draw solutes may then be returned, such as by a recycle system, back to the concentrated draw solution. Gaseous solutes may be condensed or absorbed to form a concentrated draw solution. An absorber may use dilute draw solution as an absorbent. In other embodiments, product water may be used as an absorbent for all or a portion of the absorption of the gas streams from a solute recycling system.

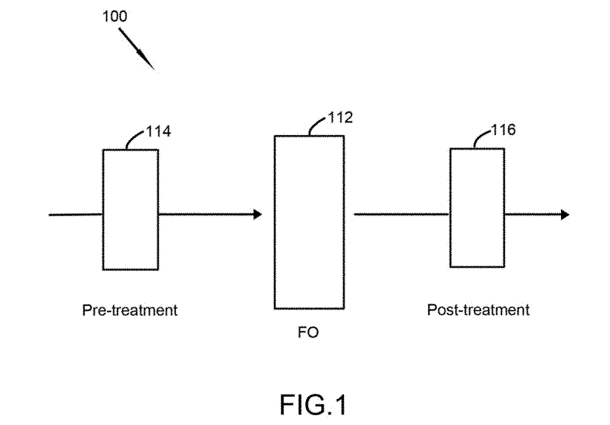

FIG. 1 depicts a schematic of a system 100 for osmotic extraction of a solvent using a forward osmosis system/process 112 including one or more pretreatment and/or post-treatment unit operations 114, 116. Various forward osmosis systems and processes can be used, such as those described herein and further described in U.S. Pat. Nos. 6,391,205 and 8,002,989; 9,352,281; 9,248,405; 9,266,065; and 9,039,899; the disclosures of which are hereby incorporated by reference herein in their entireties.

The system 100 may include one or more pretreatment operations 114 to enhance the forward osmosis process 112. The pretreatment operation can include at least one of a heat source for preheating the first solution, means for adjusting the pH of the first solution, means for disinfection (e.g., chemical or UV), separation and clarification, a filter or other means for filtering the first solution (e.g., carbon or sand filtration, nanofiltration, or reverse osmosis), heat exchange, means for polymer addition, use of an anti-scalant, ion exchange, or means for softening (e.g., lime softening) the first solution.

The system 100 may include one or more post-treatment operations 116. The post-treatment systems/operations can include at least one of a reverse osmosis system, an ion exchange system, additional forward osmosis processes, a distillation system, a pervaporator, a mechanical vapor recompression system, a heat exchange system, or a filtration system. Post-treatment may reduce product water salinity below that produced by a single pass forward osmosis system. In other examples, post-treatment may alternatively or additionally be used to remove draw solutes that would otherwise be present in a product stream. Forward osmosis brine discharge may be post-treated using ion exchange, distillation, pervaporation, membrane distillation, aeration, biological treatment or other process to remove draw solutes that reverse diffuse into brine. Additional post-treatment operations can include zero liquid discharge (ZLD) treatment using, for example, crystallization and evaporation. In one embodiment, the ZLD treatment uses a forward osmosis system, for example, in place of an evaporation system. In additional embodiments, the system can also include a recycling system including an absorber configured to facilitate reintroduction of the draw solutes to the second chamber to maintain the desired molar ratio of the draw solution.

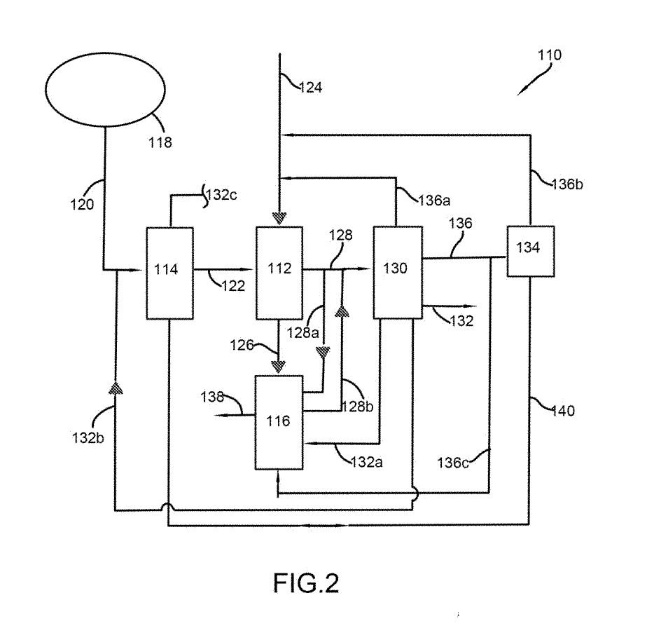

FIG. 2 depicts one possible application of the system 100 for osmotic extraction of a solvent. As discussed with respect to FIG. 1, the system 100 includes the forward osmosis system 112 and one or more pre- and post-treatment units 114, 116. The system 100 can include any combination of pre- and/or post-treatment units 114, 116 in conjunction with one or more forward osmosis systems 112, including only pretreatment or only post-treatment. The various systems/units described herein may be interconnected via conventional plumbing techniques and can include any number and combination of components, such as pumps, valves, sensors, gauges, etc., to monitor and control the operation of the various systems and processes described herein. The various components can be used in conjunction with a controller as required or desired for a particular application.

As depicted in FIG. 2, the system 100 is used to treat an impaired water source 118 (e.g., seawater, brackish water, or an industrial wastewater). As shown, a feed stream 120 is directed to the pretreatment unit 114, where the feed stream is, for example, heated. Once the feed stream has been pretreated, the treated stream 122 is then directed to the forward osmosis system 112, where it provides the first solution as discussed above. Optionally, the treated stream 122 could be directed to additional pretreatment units for further processing (e.g., pH adjustment) before entering the forward osmosis system 112. In some embodiments, the pretreatment unit 114 can include a reverse osmosis module to concentrate the feed 120 prior to introducing it to the forward osmosis system. This arrangement can be particularly useful where the initial feed has a low salinity. A draw solution is provided to the forward osmosis system 112 via stream 124 to provide the osmotic pressure gradient necessary to promote transport of the solvent across the membrane, as discussed herein.

At least two streams exit the forward osmosis system 112: a concentrated feed or treated stream 126, from which solvent has been extracted; and a dilute draw stream 128, to which solvent has been added. The concentrated stream 126 can then be directed to a post-treatment unit 116 for further processing, such as a second forward osmosis system to recover additional solvent. Additional post-treatment processes may be utilized, for example, crystallization and evaporation, to further provide for zero liquid discharge. The fully processed or concentrated feed can be disposed of, recycled, or otherwise reclaimed depending on the nature of the concentrate (arrow 138).

The dilute draw stream 128 can be directed to a separation system 130, where the solvent and/or draw solutes can be recovered. Optionally, the dilute draw stream 128 can also be directed to a post-treatment unit as desired for additional processing (stream 128a), for example, the dilute draw solution can be preheated before being directed to the separation system 130 (stream 128b). In one or more embodiments, the separation system 130 separates the draw solutes from the dilute draw stream 128 to produce a substantially purified solvent stream 132, for example, potable water, and a draw solute stream 136. In one or more embodiments, the solvent stream 132 can also be directed to a post-treatment unit for further processing (stream 132a) depending on the end use of the solvent. For example, the solvent can be further treated via distillation to remove additional draw solutes that may still be present in the solvent. In one or more embodiments, the draw solute stream 136 can be returned directly to the draw stream 124 (stream 136a), directed to a recycling system 134 for reintegration into the draw stream 124 (stream 136b), or directed to a post-treatment unit (stream 136c) for further processing depending on the intended use of the recovered draw solutes. In one or more embodiments, the recycling system 134 can be used in conjunction with the pretreatment unit 114 to, for example, provide heat exchange between the feed stream 120 and the heated draw solution stream 140.

In another possible application, where the system 100 is used to treat a low-salinity feed 120, the pretreatment system 114 can be a reverse osmosis unit that concentrates the feed 120 before directing it to the forward osmosis system 112. In this example, the pretreatment unit 114 provides a solvent/permeate stream 132c and a concentrated feed stream 122 for treatment by the forward osmosis module 112. Additionally, this pretreatment/reverse osmosis unit 114 can be used in conjunction with or in place of a post-treatment unit 116 that treats the product solvent 132 from the separation system 130 (stream 132a). Specifically, a product solvent stream 132b is directed from the separation system 130 to the feed stream 120, where it can be combined therewith and introduced into the pretreatment/reverse osmosis unit 114. Alternatively or additionally, the product stream 132b can be fed directly into the unit 114. Generally, the various streams can be directed between the various treatment units 114, 116, modules 112, and subsystems as necessary to optimize the operation of the process.

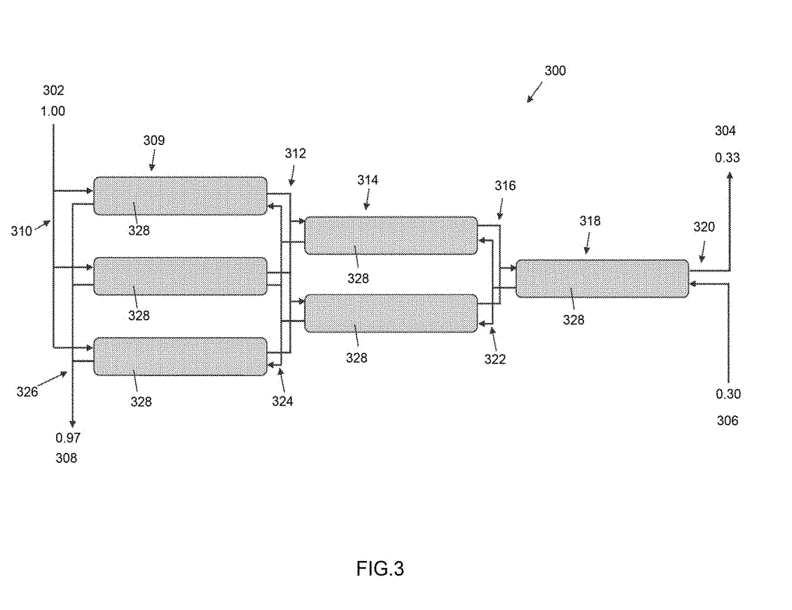

FIG. 3 depicts a forward osmosis system 300 having a pyramidal membrane configuration including three stages or banks 309, 314, 318 of FO elements. The three banks 309, 314, and 318 are arranged in a 3:2:1 configuration, meaning that, in the direction of flow of the feed solution (from a feed system inlet 302), the feed solution passes through a first bank 309 having three times as many FO elements 328 as that of the last bank 318. The middle bank 314 includes two times as many FO elements 328 as the last bank 318. As such, the configuration depicted in FIG. 3 is entirely scalable; i.e., any number of membrane elements can be included in, for example, the first bank with the other banks having elements in the proper ratio. Therefore, depending on the performance required or desired for a particular application, the number of FO elements 328 may be selected based on the feed solution volume at a particular flow rate and/or on a particular draw solution concentration. Thus, the number of FO elements can be optimized based on the particular configuration. Generally, pyramidal configurations of membranes are oriented so that the feed solution first passes through a first FO element bank 309 having a greater number of FO elements than a subsequent FO element bank. As flow continues, the second FO element bank 314 has a greater number of FO elements than the third FO element bank 318, and so on. Each subsequent FO element bank, e.g., from bank 309 to bank 314 and from bank 314 to bank 318, has a lower feed solution flow rate.

FIG. 3 also depicts relative solution flows at each of the feed system inlet 302, a concentrated feed system outlet 304, a concentrated draw system inlet 306, and a diluted draw system outlet 308. The system 300 is configured as a 0.3:1.0 draw-to-feed flow ratio. A flow of 1 base unit passes through the feed system inlet 302. As the feed solution flows through the system 300, its volumetric flow decreases while the volumetric flow of the concentrated draw solution increases in the opposite flow direction. This is due to the forward osmotic flow of solvent from the feed solution to the draw solution. The concentrated draw solution is pumped into the concentrated draw system inlet 306, or in an alternative example, diluted draw solution is drawn from the diluted draw system outlet 308. Regardless of whether the draw system is under positive or negative pressure, it is desirable to maintain the highest possible osmotic pressure across the membrane to maximize flux from the feed to the draw side of the membrane and to keep the differential pressure across the membrane from the feed side to the draw side positive to prevent delamination of the membrane. It has been determined that a pressure of less than about 100 psi on the draw side is desirable. As such, the 3:2:1 system configuration depicted in FIG. 3 would be designed to a pressure drop lower than this value. Other pressure drops are contemplated and may be dictated by flow rate, water and/or brine concentrations, etc.

In further detail, the depicted pyramid membrane configuration 300 includes the feed solution inlet 302 that is fed to the first FO element bank 309 via a feed inlet manifold 310 (e.g., a piping header or manifold block incorporating valving). After exiting the first FO element bank 309, the feed solution passes through a first feed system manifold 312 and enters a second FO element bank 314. Thereafter, the feed solution passes through a second feed system manifold 316 and enters a third FO element bank 318, before leaving the system at a system feed outlet 320; however, it should be noted that the membrane arrangement may include more than three membrane banks. In a flow reverse from that of the feed solution, the concentrated draw solution enters the system at the draw system inlet 306, and passes through, sequentially, the third FO element bank 318, a first draw system manifold 322, the second FO element bank 314, a second draw system manifold 324, and the first FO element bank 309, before exiting the system 300 via a draw system outlet manifold 326. Each manifold 312, 316, 322, and 324 directly connects fluid flow between adjacent FO element banks 309, 314, 318 and may include any necessary valves, sensors, etc. for controlling the system.

This 3:2:1 pyramidal membrane configuration helps draw water across the membranes in each FO element, from the feed solution to the concentrated draw solution. In general, at the first FO element bank 309, water concentrations within the feed solution are relatively high. However, since the draw solution has already passed through a number of FO elements (namely, the third FO element bank 318 and the second FO element bank 314), the water concentration therein is higher than when the concentrated draw solution is first introduced at the concentrated draw system inlet 306. As such, osmotic efficiencies are lower at the first FO element bank 309 than may be desirable. Notwithstanding the performance of the 3:2:1 pyramidal membrane configuration, the system 300 may display certain shortcomings, which are addressed by the configurations depicted below.

Generally, the feed stream is introduced into a first forward osmosis module/array/bank that is divided into first chamber(s) or side(s) and second chambers/sides by semi-permeable membrane(s). The feed stream is directed to each successive forward osmosis module and exits the last module as the concentrated feed stream. The specific number and arrangement of forward osmosis modules will be selected to suit a particular application (e.g., starting concentration and required final concentration of the feed stream, flux and flow rates, etc.) and can include any number of modules arranged in series and/or parallel. For example, multiple parallel pairs of forward osmosis modules may be arranged in series, as generally shown in the figures. The concentrated draw solution is typically introduced to the last module in the series of forward osmosis modules and to the opposite sides of the membranes as the feed stream, thereby providing a counter-flow between the feed stream and the draw solution, as the draw solution is directed through the successive modules. However, the concentrated draw solution could be first introduced into the same module as the feed stream is first introduced and/or could be introduced into multiple stages concurrently (i.e., in parallel) to suit a particular application. In addition, the various streams/solutions can be adjusted/divided as necessary to achieve an optimum differential osmotic pressure as necessary to maintain the desired flux across the membranes.

In a counter-flow arrangement, the feed stream becomes more concentrated as it passes through each forward osmosis module, with the afore-mentioned concentrated feed stream being discharged from the final forward osmosis module. The concentrated draw solution becomes diluted as it passes through each successive forward osmosis module due to the passage of solvent across the membranes from the feed stream into the draw solution; discharging a dilute draw solution from the “first” forward osmosis module. Typically, the concentrated feed stream is discarded or sent for further processing, while the dilute draw solution is directed to a separation/recycling system to recover draw solutes/re-concentrate the draw solution and recover product solvent (e.g., water). Alternatively or additionally, a portion of the more concentrated feed stream exiting each forward osmosis module 12 can be redirected back to and combined with the initial feed stream, directed to a subsequent forward osmosis module as necessary to maintain an optimum differential osmotic pressure across the membranes, and/or recirculated within a module. Generally, when operating the membrane modules in a series arrangement, it is usually desirable to operate with a counter-flow of the feed stream and the draw solution as shown in the figures, so that the feed stream concentration increases as it flows through the modules and the draw solution concentration decreases as it flows through the modules. This arrangement results in the least concentrated feed stream opposing the least concentrated draw solution across the membrane in the first membrane module and the most concentrated feed stream opposing the most concentrated draw solution across the membrane in the “last” membrane module. This results in an optimum differential osmotic pressure across all of the modules.

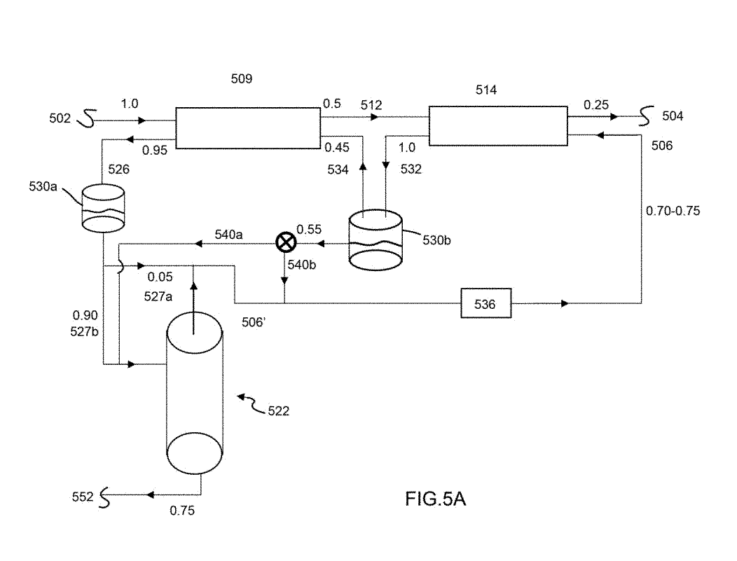

Typical membrane arrays (i.e., multiple banks or stages of modules holding one or more membranes) operate at relatively low flux; however, higher fluxes are more desirable. Unfortunately, achieving higher fluxes in an array comes with a considerable energy penalty and increased complexity. In some embodiments, by moving away from a pyramidal membrane array configuration towards a reverse pyramid or even something closer to linear (e.g., all or a portion of the membrane configuration may be linear as shown in FIGS. 5 and 5A), draw solution flow can be greatly increased and with the addition of a bypass of all or a portion of the draw solution between membrane stages, the ill-effects of the pressure drop across membrane banks required to achieve the optimal flow velocities are mitigated or eliminated. The foregoing changes in membrane configurations maintain or lower the energy required to recover draw solutes (e.g., by feeding a higher concentration draw solution to the separation system) and greatly reduce the total number of membrane elements required for similar levels of recovery, which in turn improves system rejection.

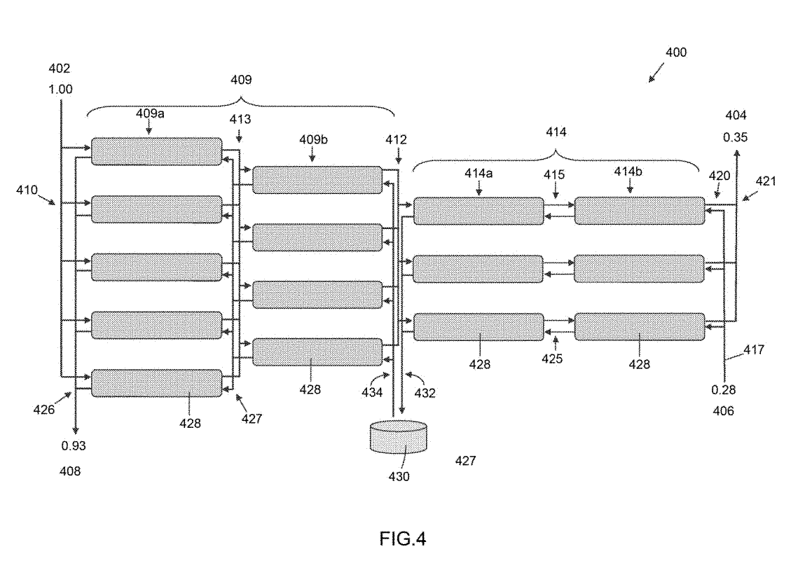

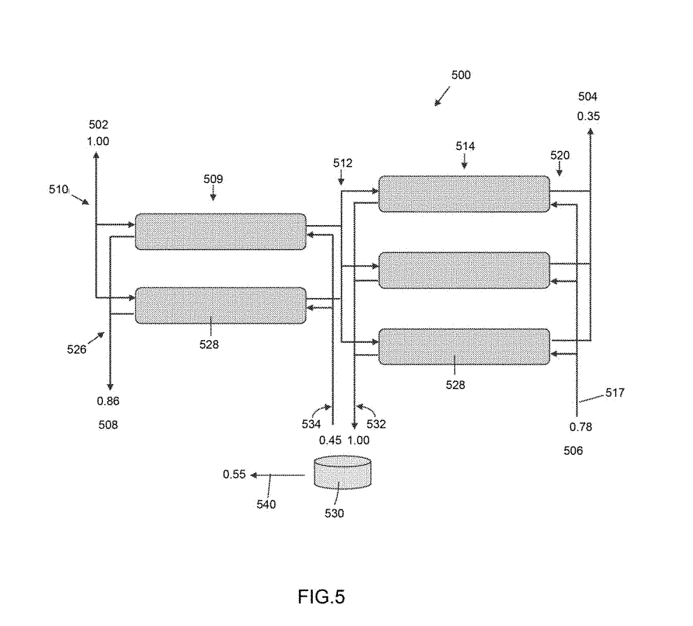

FIGS. 4-6 depict examples of alternative membrane configurations for forward osmosis systems. In a radical departure from prior approaches, the depicted configurations utilize a break in the draw solution system in the form of a bypass tank (or other means, e.g., a bypass valve, that allows the user to redirect or dispose of a portion of the draw solution) that temporarily retains a portion of the draw solution passing through the system. As such, the draw solution flow path in the configurations of FIGS. 4-6 may be characterized as “indirect,” while the feed solution flow path may be characterized as “direct,” in that no breaks are present. Due to the presence of this bypass tank, higher flow velocities may be utilized without damage to the membranes. Since these increased flow velocities also increase pressure drop across the membranes, the bypass tanks act as pressure reset vessels at approximate midpoints of each system. However, multiple bypass tanks may located throughout the system, for example, between each bank of membranes or strategically placed to suit a particular application. In addition, all or portions of the draw solution exiting a membrane bank can be directed to multiple or non-adjacent bypass tanks or even recirculated to optimize the osmotic pressure differential across any particular membrane bank to optimize overall performance of the system (e.g., maximum solvent recovery/feed concentration). The increased velocity through each system allows for better recovery without diluting the draw system as significantly as the configuration of FIG. 3. Additionally, the use of the bypass tank can include a boost pump to assist in pushing the draw solution through a particular membrane bank(s) as opposed to requiring an initial higher pressure to get the draw solution through an entire membrane system, such as in a pyramidal membrane configuration.

In the example depicted in FIG. 4, the forward osmosis membrane configuration 400 is in a 3:2 configuration relative to the location of the bypass tank, with bank 409 having a greater number of FO elements 428 than adjacent bank 414. This 3:2 configuration is also scalable and as shown can also be referred to as a 5:4:3:3 configuration. Moreover, in a further distinction from preliminary approaches, the first FO element bank 409 includes membrane array subsets 409a, 409b (also sometimes referred to as additional stages) having different numbers of FO elements in each subset to suit a particular application (e.g., feed volume, desired recovery, etc.). The membrane array subsets 409a, 409b depicted are arranged in a 5:4 configuration, where the first subset 409a includes five (or multiples thereof) FO elements 428, while the second subset 409b includes four (or multiples thereof) FO elements 428; however, the exact number and arrangement of membrane elements within an array subset will vary to suit a particular application. The second bank 414, however, includes two subsets 414a, 414b in a 1:1 or linear configuration of any particular number of membrane elements, such as the three (or multiples thereof) shown in each subset 414a, 414b. This modified pyramidal configuration allows adjacent FO elements in the subsets 414a, 414b to be connected by dedicated conduits 415, 425, instead of utilizing manifolds, as depicted elsewhere herein. However, as with the first bank 409, any number of subsets and individual membrane elements, and the ratios thereof can be selected to suit a particular application.

In further detail, the depicted membrane configuration 400 includes a feed system inlet 402 and a concentrated feed system outlet 404, as well as a concentrated draw system inlet 406 and a diluted draw system outlet 408. Between the feed system inlet 402 and the concentrated feed system outlet 404 is a feed solution flow path. Between the concentrated draw system inlet 406 and the diluted draw system outlet 408 is a draw solution flow path. Importantly, the feed system inlet 402 is disposed proximate the first FO element bank 409 and introduced thereto via a feed inlet manifold 410. The first feed FO element bank 409 includes the first subset 409a of FO elements, which are connected via a manifold 413 to the second subset 409b of FO elements. After exiting the first FO element bank 409, the feed solution passes through a first feed system manifold 412 and enters the second FO element bank 414. Like the first FO element bank 409, the second FO element bank 414 includes the first subset 414a of FO elements, each of which are directly connected via dedicated conduits 415 to one of the second subset 414b of FO elements. As such, no manifold is utilized between the first subset 414a and second subset 414b of FO elements. The feed solution exits the system at a system feed outlet 420 after passing through a feed system outlet manifold 421.

In a flow direction in reverse from that of the feed solution, the concentrated draw solution enters the system 400 at the draw system inlet 406 and a draw system inlet manifold 417, and passes through the second FO element bank 414. Similar to the feed solution side, on the draw solution side, each of the second subset 414b of FO elements is directly connected via dedicated conduits 425 to one of the first subset 414a of FO elements. However, a bypass manifold and tank as described below could also be disposed between the second and first membrane array subsets 414b, 414a. After exiting the second FO element bank 414 via an outlet bypass manifold 432, the draw solution is discharged into the bypass tank 430, which may be at a pressure different than that of the remainder of the system 400 (e.g., atmospheric). After the bypass tank 430, an inlet bypass manifold 434 delivers draw solution to the first FO element bank 409, specifically to the second subset 409b thereof via, for example, a pressure transfer device, such as a pump. The second subset 409b of the first FO element bank 409 is connected to the first subset 409a via a manifold 427. Once passed through the first subset 409a of the first FO element bank 409, the now-diluted draw solution exits the system 400 via a draw outlet manifold 426, where it can be sent for further processing as described elsewhere herein.

FIGS. 5 and 5A depict systems 500 that incorporate alternative membrane configurations. The system 500 of FIG. 5 utilizes a reverse pyramidal configuration compared to the system 300 depicted in FIG. 3. In the depicted reverse pyramidal configuration, the feed solution enters the system 500 at a first FO element bank 509 that includes fewer FO elements than the second FO element bank 514. More specifically, the system 500 of FIG. 5 is a scalable 2:3 configuration relative to the bypass circuit; however, more than two membrane banks may be included (e.g., a 2:3:4 configuration is possible). In a departure from existing designs, such as FIG. 3 where the design focuses on generally symmetrical flow rates between the feed solution and the draw solution, the number of FO element banks in system 500 allows for greater variability of the relative flow rates between the feed solution and the draw solution. That is, the flow rate of the draw solution is, for example, 0.78 when entering FO element bank 514 and is 1.00 upon exiting FO element bank 514. In FO element bank 509, the flow rate of the draw solution enters at 0.45 and exits at 0.86. As such, there are more FO element banks when the draw solution flow rate is highest. In contrast, the feed solution flow rate is highest when there are the fewest FO element banks (e.g., FO element bank 509, as compared to FO element bank 514), when the feed solution flow rate is lower. This is a dramatic change from previous forward osmosis systems. This configuration allows the draw solution to draw more water from the feed solution than in the pyramidal configuration depicted in FIG. 3, while using fewer FO elements. Additionally, the system 500 incorporates an indirect draw solution flow configuration that allows for increased osmotic pressure within parts of the system 500, so as to improve osmotic flow between the feed and draw solutions.

In further detail, the depicted reverse pyramid membrane configuration 500 includes a feed system inlet 502 and a concentrated feed system outlet 504, as well as a concentrated draw system inlet 506 and a diluted draw system outlet 508. Between the feed system inlet 502 and the concentrated feed system outlet 504 is a feed solution flow path. Between the concentrated draw system inlet 506 and the diluted draw system outlet 508 is a draw solution flow path. The feed system inlet 502 is connected to the first FO element bank 509 via a feed inlet manifold 510. After exiting the first FO element bank 509, the feed solution passes through a first feed system manifold 512 and enters the second FO element bank 514. The feed solution exits the system at a system feed outlet 520 after passing through a feed system outlet manifold 521. In a flow reverse from that of the feed solution, the concentrated draw solution enters the system 500 at the draw system inlet 506 and a draw system inlet manifold 517, and passes through the second FO element bank 514 and an outlet bypass manifold 532, before being discharged into a bypass tank 530, which may be at a pressure different than that of the remainder of the system 500 (e.g., atmospheric). After the bypass tank 530, an inlet bypass manifold 534 delivers draw solution to the first FO element bank 509, then the now-diluted draw solution exits the system 500 via a draw outlet manifold 526. The bypass tank 530 can also be connected to a bypass line 540 that may be routed to a thermal recovery system, as described in more detail below. A relative portion of this amount diverted to the thermal recovery system via the bypass line 540 is also depicted. Additionally, the use of the bypass can provide for a reduction in the draw solution volume passing through the membrane elements, thereby reducing or eliminating any risk of bursting a membrane because of an excessive increase in draw solution volume via the solvent fluxing across the membranes.

Generally, FIG. 5A depicts a linear membrane configuration that is essentially a simplified version of FIG. 5, where there is the same number of membranes in each bank (with essentially any number of membranes in a membrane bank) and an inter-stage bypass system disposed therebetween. Two membrane banks 509, 514 are depicted with a single bypass tank 530 (i.e., a 1:1 configuration); however, multiple linear membrane banks with one or more inter-stage bypass systems are contemplated and considered within the scope of the invention. FIG. 5A also depicts a simplified separation system 522 that receives a portion 540 of the partially diluted draw solution that can be used to assist in draw solute recovery and optimize draw solution re-concentration. For example, a portion 540a of partially diluted draw solution from the bypass tank 530b can be directed to the separation system 522 to be added to the dilute draw solution from the dilute draw solution tank 530a at the end of the membrane array to optimize the draw solution concentration (e.g., make the draw solution more or less dilute) into the separation system 522 for maximum draw solution recovery. Alternatively, a portion 540b of partially diluted draw solution from the bypass tank 530b can be directed to the separation system downstream of any draw solute recovery device within the separation system 522 (e.g., a distillation column or filtration unit) and combined with the at least partially re-concentrated draw solution 506′ to assist in further concentrating the draw solution as it is sent to a condenser/absorber system 536. For example, the more dilute portion 540b can be combined with the more concentrated draw solution 506′ to assist in obtaining a desired molar ratio of the final concentrated draw solution 506. In addition, the dilute draw solution manifold 526 can direct the dilute draw solution to a holding tank 530a that includes two branches 527a, 527b exiting therefrom to provide two different portions of the dilute draw solution to the separation system 522 (e.g., a larger portion from branch 527b to a thermal separation device, such as a distillation column, and a smaller portion from branch 527a added to the recovered draw solutes exiting the thermal separation device).

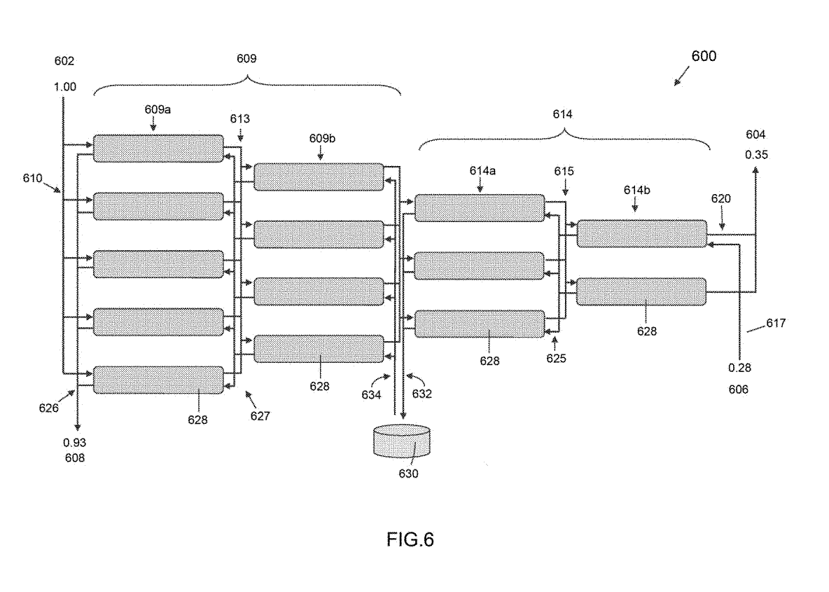

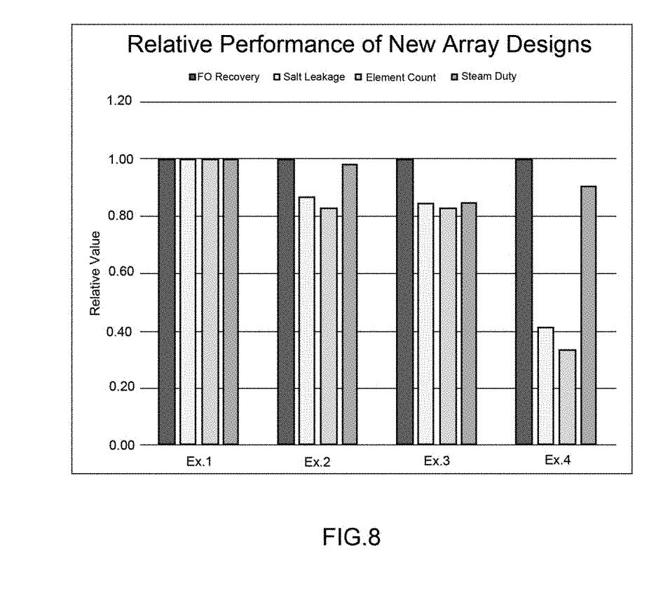

FIG. 6 depicts a system 600 that utilizes both a pyramidal configuration and a bypass tank, similar to the system depicted in FIG. 4. The reference numerals utilized in FIG. 6 are similar to those utilized in FIG. 4, however, not all elements of FIG. 6 are necessarily described below. The system 600 deviates from the system 400 of FIG. 4, in that it is a scalable 9:5 configuration. As such, the first FO element bank 609 includes nine (or multiples thereof) FO elements 628, while the second FO element bank 614 includes five (or multiples thereof) FO elements 628 in multiple stages 609a, 609b, 614a, 614b as shown in FIG. 6. For example, the first bank 609 includes the first stage or subset 609a having 5×FO elements 628 and the second stage or subset 609b of 4×FO elements 628 and the second bank 614 includes the first stage or subset 614a having 3×FO elements 628 and the second stage or subset 614b of 2×FO elements 628. The first subset 614a and second subset 614b are connected via manifolds 615, 625 on both the feed and draw sides of the system 600. The effect on performance due to this configuration is noted below, e.g., in FIG. 8.

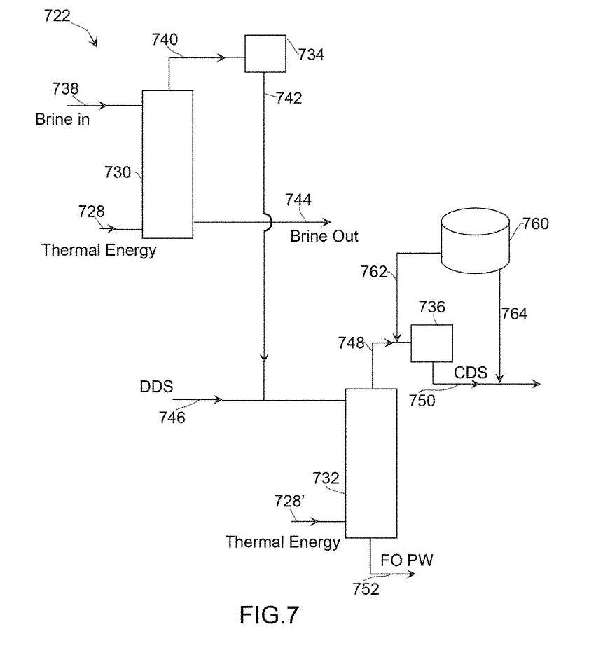

FIG. 7 depicts an exemplary thermal recovery system 722 that includes a brine stripper column 730 and a dilute draw solution column 732. Similar systems are described in the incorporated references. Brine 738 and dilute draw solution 746 are introduced into their respective columns, along with a source of thermal energy 728, 728′. Draw solutes and/or water are vaporized out of the brine stripper column 730. The vapor 740 can be directed to an optional compressor 734, the output 742 of which is directed to the input of the draw solution column 732. In some embodiments, an optional compressor can be similarly used with the dilute draw solution column 732. The further concentrated brine 744 is outputted from the bottom of the column 730, where it can be sent for further processing or otherwise discarded. The draw solutes 748 vaporized out of the draw solution column 732 are directed to a condenser system (e.g., a simple condenser or a combined condenser/absorber circuit) 736, the output of which is concentrated draw solution 750. From the bottom of the column 732, the product solvent 752 is recovered for use or further processing.

FIG. 7 also depicts a location of a bypass tank 760, such as those depicted above in FIGS. 4-6. Typically all or at least a substantial portion of the dilute draw solution is directed from the bypass tank to the next membrane bank. However, in some embodiments, a portion of the dilute draw solution 762 from the bypass tank 760 may be introduced to the system 722 as required or desired for a particular application. For example, the portion of dilute draw solution 762 redirected from the bypass tank 760 can be introduced downstream of the condenser to assist in the absorption of vaporized draw solutes. In some embodiments, the portion of dilute draw solution 762 from the bypass tank 760 enters the system 722 upstream of the condenser 736 to suit a particular application. The efficiency of the thermal recovery system 722 is related to the molarity of the dilute draw solution received from the forward osmosis systems. For example, the forward osmosis systems 400, 500, and 600 with bypass take-offs force the molarity of the dilute draw solution higher, as compared to the dilute draw solution exiting a typical pyramid membrane arrangement 300. Forcing the molarity higher drops the water vapor fraction and reduces the energy costs to extract draw solutes from the dilute draw solution (i.e., re-concentrating the draw solution for reuse within the systems.

FIG. 8 depicts performance data for the various forward osmosis systems depicted herein, in particular, relative performance of the systems depicted in FIGS. 3-5. Four example configurations are depicted. Example 1 is consistent with the 3:2:1 element configuration of FIG. 3, while Example 2 also represents a 3:2:1 element configuration, but having a fewer number of total FO elements. Example 3 is consistent with the 3:2 configuration of FIG. 4, while Example 4 is consistent with the 2:3 configuration of FIG. 5. For the metrics depicted in FIG. 8, where the FO recovery is substantially a constant, lower relative values depict more desirable characteristics. With all Examples, a reduction in the number of FO elements results generally in reduced salt leakage, since salt leakage occurs across all FO elements, which in turn reduces the energy requirements for recovering draw solutes and/or producing a final product solvent. Notably, a reduction in the number of FO elements between Example 1 and Example 2 has minimal effect on FO Recovery or Steam Duty (Thermal Duty). As such, reducing the number of FO elements in the configuration of FIG. 3 may be desirable, since this lowers capital expenditures associated with the price of FO elements, while having little effect on operational expenses associated with steam duty. However, Examples 3 and 4 depict greater savings for capital expenditures (e.g., fewer individual membrane elements) and for operational expenses (e.g., lower steam duty).

Interestingly, Example 3 displays slightly reduced costs associated with steam duty, as compared to that of Example 2. This may indicate that use of a bypass tank contributes to overall performance in pyramidal systems, since eliminating direct flow reduces the number of elements in the system. In Example 4, which includes a bypass tank in conjunction with a reverse pyramid system, FO element count decreases dramatically, with minimal decrease in forward osmosis recovery as compared to the other systems. Steam Duty decreases slightly as well.

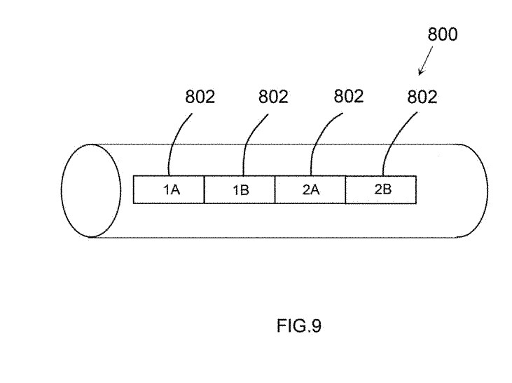

FIG. 9 is a schematic representation of an alternative spiral wound FO membrane array 800 containing multiple stages 802; however, in some embodiments, the membrane array 800 is a single membrane containing 4-8 individual membrane elements 802, as opposed to stages. In the systems of FIGS. 4-6, each FO element is the same in each FO element bank. FO element 800 accomplishes the advantages of the systems described above by configuring each FO element or elements in highly specialized configurations. As such, the FO elements can be arranged in a one-to-one system: a single, specialized, FO element bank followed by a bypass and then another single, specialized, FO element bank. The difference in the FO membrane array 800 depicted in FIG. 9 versus a conventional spiral wound membrane array is that the membranes or membrane elements 802 within a particular stage (1A, 1B, 2A, 2B) are different. For example, typical spiral wound FO membranes have a geometry based on a 0.3:1 draw to feed ratio and three stage arrangement, where each element is virtually identical. The membrane array depicted in FIG. 9 contains specialized elements with different draw leaf and feed screen arrangements in different stages that are selected to achieve a lowest cost per square foot of active membrane area and optimal fluid velocity through the membrane. Generally, each membrane stage (stages 802) includes four to eight specialized membrane element configurations. For example, in one embodiment, the elements in stages 2A and 2B incorporate membrane elements having narrower feed screens than the elements in stages 1A and 1B, which increases feed velocity through and packing density of the elements in stages 2A and 2B. In some embodiments, the elements in stages 1A and 2A use shorter membrane draw leaves relative to the elements in stages 1B and 2B to limit pressure drop through stages 1A and 2A, while the longer leaves used in the elements in stages 1B and 2B reduce the labor costs to manufacture those elements. These FO membrane arrangements can be utilized in the systems described above to further improve performance and efficiency of the systems, as well as reducing capital and operational expenses. In some embodiments, individual elements within a membrane can vary in the same manners as those described above.

Additional cost savings can be realized by further improving membrane performance and extending the membrane's life. For example, some materials/components in the FO element may be susceptible to degradation (e.g., loss of tensile strength) at elevated concentrations of certain types of draw solutions and/or at elevated temperatures. Adverse effects may also occur when individual elements are exposed to elevated trans-membrane pressures (e.g., feed screen buckling), which may vary relative to an element's position within the membrane housing. If the amount of exposure to any of these factors can be reduced, the lifetime of the element can be extended.

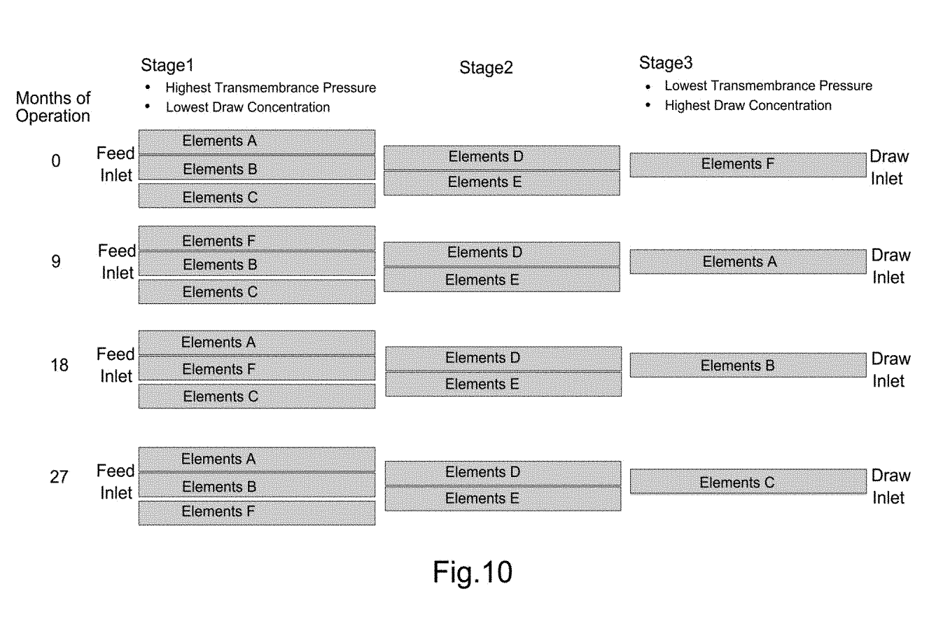

Exposure may be limited by periodically rotating membrane elements in the first stage or bank of a membrane array with those in the final stage/bank of a membrane array. One example of this process is depicted in FIG. 10. Generally, the rotation process can be done at predetermined intervals, randomly, or when deemed necessary based on one or more measured process conditions. For example, in a 3-2-1 pyramid configuration as shown in FIG. 10 and assuming a membrane element with an expected 3 year lifetime on the elements, the elements from stage 3 could be exchanged for elements in one of the membrane housings in stage 1 every 9 months. In one embodiment, the rotation is carried out by physically exchanging elements between housings; however, this change in orientation could also be accomplished with flexible plumbing that redirects feed and draw streams to the various stages.

In accordance with one or more embodiments, the devices, systems and methods described herein may generally include a controller for adjusting or regulating at least one operating parameter of a device or a component of the systems, such as, but not limited to, actuating valves and pumps, as well as adjusting a property or characteristic of one or more fluid flow streams through a membrane module, or other module in a particular system. A controller may be in electronic communication with at least one sensor configured to detect at least one operational parameter of the system, such as a concentration, flow rate, pH level, or temperature. The controller may be generally configured to generate a control signal to adjust one or more operational parameters in response to a signal generated by a sensor. For example, the controller can be configured to receive a representation of a condition, property, or state of any stream, component, or subsystem of the osmotically driven membrane systems and associated pre- and post-treatment systems. The controller typically includes an algorithm that facilitates generation of at least one output signal that is typically based on one or more of any of the representation and a target or desired value, such as a set point. In accordance with one or more particular aspects, the controller can be configured to receive a representation of any measured property of any stream, and generate a control, drive or output signal to any of the system components, to reduce any deviation of the measured property from a target value.

In accordance with one or more embodiments, process control systems and methods may monitor various concentration levels, such as may be based on detected parameters including pH and conductivity. Process stream flow rates and tank levels may also be controlled. Temperature and pressure may be monitored. Membrane leaks may be detected using ion selective probes, pH meters, tank levels, and stream flow rates. Leaks may also be detected by pressurizing a draw solution side of a membrane with gas and using ultrasonic detectors and/or visual observation of leaks at a feed water side. Other operational parameters and maintenance issues may be monitored. Various process efficiencies may be monitored, such as by measuring product water flow rate and quality, heat flow and electrical energy consumption. Cleaning protocols for biological fouling mitigation may be controlled such as by measuring flux decline as determined by flow rates of feed and draw solutions at specific points in a membrane system. A sensor on a brine stream may indicate when treatment is needed, such as with distillation, ion exchange, breakpoint chlorination or like protocols. This may be done with pH, ion selective probes, Fourier Transform Infrared Spectrometry (FTIR), or other means of sensing draw solute concentrations. A draw solution condition may be monitored and tracked for makeup addition and/or replacement of solutes. Likewise, product water quality may be monitored by conventional means or with a probe such as an ammonium or ammonia probe. FTIR may be implemented to detect species present providing information which may be useful to, for example, ensure proper plant operation, and for identifying behavior such as membrane ion exchange effects.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is, therefore, to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

1. A forward osmosis system comprising:
a system feed inlet;
a first forward osmosis (FO) element bank connected to the system feed inlet and comprising a plurality of primary FO elements;
a second FO element bank comprising a plurality of secondary FO elements;
a system feed transfer configured for direct fluid flow from the first FO element bank to the second FO element bank;
a system draw inlet connected to the second FO element bank;
a system draw outlet connected to the first FO element bank; and
a system draw transfer configured for indirect fluid flow from the second FO element bank to the first FO element bank.

2. The forward osmosis system of claim 1, wherein the system draw transfer comprises a bypass tank.

3. The forward osmosis system of claim 1, wherein the bypass tank comprises a bypass outlet configured to be connected to a separation system.

4. The forward osmosis system of claim 1, wherein the plurality of secondary FO elements are a number greater than the plurality of primary FO elements.

5. The forward osmosis system of claim 1, wherein the plurality of primary FO elements comprises a first subset of primary FO elements and a second subset of primary FO elements having a number greater than the first subset of primary FO elements.

6. The forward osmosis system of claim 5, further comprising a feed system manifold connecting the first subset of primary FO elements and the second subset of primary FO elements.

7. The forward osmosis system of claim 5, wherein the plurality of secondary FO elements comprises a first subset of secondary FO elements and a second subset of secondary FO elements having a number equal to the first subset of secondary FO elements.

8. The forward osmosis system of claim 5, wherein the system feed transfer connects the second subset of primary FO elements to the second FO element bank.

9. The forward osmosis system of claim 7, wherein a feed outlet of a single one of the first subset of secondary FO elements is connected to feed inlet of a single one of the second subset of secondary FO elements.

10. The forward osmosis system of claim 1, wherein the system feed transfer comprises a manifold.

11. The forward osmosis system of claim 1, wherein the plurality of primary FO elements are a number greater than the plurality of secondary FO elements.

12. A forward osmosis system comprising:
a plurality of forward osmosis (FO) element banks comprising forward osmosis membranes having first and second opposing sides;
a feed solution inlet;
a feed solution outlet;
a feed solution flow path configured for direct fluidic communication from the feed solution inlet, through the plurality of FO element banks via the first sides of the forward osmosis membranes, and to the feed solution outlet;
a draw solution inlet;
a draw solution outlet; and
a draw solution flow path configured for indirect fluidic communication from the draw solution inlet, through the plurality of FO element banks via the second sides of the forward osmosis membranes, and to the draw solution outlet.

13. The forward osmosis system of claim 12, wherein the draw solution flow path comprises a bypass tank for temporarily retaining at least a first portion of the draw solution in the draw solution flow path.

14. The forward osmosis system of claim 13, wherein the bypass tank comprises a bypass line for diverting at least a second portion of the draw solution in the bypass tank.

15. The forward osmosis system of claim 12, wherein the forward osmosis membranes have different physical configurations.

16. A process for concentrating a feed stream via forward osmosis, the process comprising the steps of:
providing a first bank of FO membrane elements;
providing a second bank of FO membrane elements;
introducing the feed stream into the first bank of FO membrane elements and then the second bank of FO membrane elements;
introducing a draw solution into the second bank of FO membrane elements;
introducing the draw solution exiting the second bank of FO membrane elements into a bypass tank;
introducing at least a portion of the draw solution from the bypass tank into the first bank of FO membrane elements; and
fluxing a portion of a solvent across the membrane elements from the feed stream into the draw solution.

17. The process of claim 16 further comprising the step of directing the draw solution exiting the first bank of FO membrane elements to a separation process to separate draw solutes from the solvent that fluxed across the membrane banks from the feed stream to the draw solution.

18. The process of claim 17 further comprising the step of directing a second portion of the draw solution from the bypass tank to the separation process.

19. The process of claim 16, wherein the feed stream and draw solution are introduced into the banks of FO membrane elements on opposite sides of the membrane and in a counter-flow orientation.

20. The process of claim 16 further comprising the step of periodically rotating individual membrane elements between membrane banks.
